(19) United States
(12) Patent Application Publication
(10) Pub. No.: US 2011/0029371 A1
(43) Pub. Date: Feb. 3, 2011

(54) METHOD AND SYSTEM OF ALLOCATION OF POPULARITY CREDIT IN A PRIVATE COMMUNICATIONS NETWORK

(76) Inventor: Derek Devries, San Francisco, CA (US)

Correspondence Address: RICHARD R. PETERS, 26512 AVENIDA VERONICA, MISSION VIEJO, CA, 92691, US

(21) Appl. No.: 12/837,497

(22) Filed: Jul. 16, 2010

Related U.S. Application Data
(63) Continuation-in-part of application No. 12/769,568, filed on Apr. 28, 2010.
Application No. 12/769,568 is a continuation-in-part of application No. 12/551,970, filed on Sep. 1, 2009.
(60) Provisional application No. 61/271,958, filed on Jul. 30, 2009.

(51) Int. Cl. G06Q 30/00

(52) U.S. Cl. 705/14.39; 705/14.73

(57) ABSTRACT

Disclosed are a system, method, and article of manufacture for allocation of popularity credit in a private communications network. An entity member of the private communications network provides a media content to a website member of the private communications network. Another entity member of the private communications network provides an advertisement content. A server hosts the website. The website includes the advertisement content, the media content and a hyperlink to a vendor website outside the private communications network. An administration server includes a verification module that determines whether a user purchased a good or a service from the vendor website. The administration server includes a popularity credit manager that generates a list of entities that provided the media content or hosted the media content. The popularity credit manager allocates a popularity credit to the each listed entity member if the user purchased the good or the service from the vendor website. The popularity credit manager tracks the allocation and redemption of popularity credits within the private communication network. The popularity credit manager provides a popularity credit database that is available to a member of the private communication network. The popularity credit database comprises popularity-credit allocation data and popularity-credit redemption data. A user access manager controls user access to the private communications network.

### CLAIM OF PRIORITY

This application claims priority as a continuation-in-part of U.S. patent application titled “METHOD AND SYSTEM OF CREDIT DEFERMENT IN A PRIVATE COMMUNICATIONS NETWORK”, Ser. No. 12/769,568 filed on Apr. 28, 2010, and is hereby incorporated by reference. Application Ser. No. 12/769,568 is itself a continuation-in-part of U.S. patent application Ser. No. 12/551,970 titled “ALLOCATION OF DIGITAL MEDIA STORE CREDIT FOR PRESENTATION OF AN ADVERTISEMENT WITH A MEDIA PLAYER” filed on Sep. 1, 2009. Both application Ser. Nos. 12/769,568 and 12/769,568 claim the benefit of provisional application 61/271,958 filed Jul. 30, 2009.

### FIELD OF TECHNOLOGY

This disclosure relates generally to a computer networking, and, more particularly, to a system, a method and an article of manufacture of allocation of popularity credit in a private communications network.

### BACKGROUND

Advertisers pay providers of traditional media (e.g., television, radio and print media) to place or play an advertisement. The consumers of traditional media typically have no choice as to when or how the advertisements are provided. For example, a television viewer typically watches advertisements temporally sequenced throughout a television program. The television program is not available through the television media without advertisement. This pattern holds true for the radio and print media as well. Recently, new devices (e.g. digital video recorders, mp3 players) and forms of media (e.g. video sharing websites, satellite radio) have become available that allow a consumer to filter out advertisement or provide media content without advertisements. Thus, advertisers can lose audience size and media content providers can lose advertisement revenue.

Additionally, the World Wide Web (WWW) has seen the rise of the phenomenon of the democratization of producing entertainment media. For example, a layperson can create a video and post the video on a video sharing website. The video can “go viral” and gain in popularity. However, the actions of the user and other data related to the popularity of the media content may not be available to other users of the system. Thus, other users can lack important information as to how to increase the popularity of media content they create.

### SUMMARY

A system, method, and article of manufacture for allocation of popularity credit in a private communications networking are disclosed. In one aspect, an entity member of the private communications network provides a media content to a website member of the private communications network. Another entity member of the private communications network provides an advertisement content. A server hosts the website. The website includes the advertisement content, the media content and a hyperlink to a vendor website outside the private communications network. An administration server includes a verification module that determines whether a user purchased a good or a service from the vendor website. The administration server includes a popularity credit manager that generates a list of entities that provided the media content or hosted the media content. The popularity credit manager allocates a popularity credit to the each listed entity member if the user purchased the good or the service from the vendor website. The popularity credit manager tracks the allocation and redemption of popularity credits within the private communication network. The popularity credit manager provides a popularity credit database that is available to a member of the private communication network. The popularity credit database comprises popularity-credit allocation data and popularity credit redemption data. A user access manager controls user access to the private communications network.

In another aspect, a webpage accessible via the restricted network is provided. A media content on the webpage is provided. An advertisement content on the webpage is provided. A hyperlink is provided on the webpage. The hyperlink includes a reference that instructs a web browser to access a vendor webpage. A number of credits are allocated between a webpage administrator, a media content provider and an advertisement provider if a user clicks through the hyperlink and purchases a good or a service from the vendor webpage.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a block diagram showing a schematic view of an example private communications network for implementing one or more embodiments.

FIG. 2 shows a block diagram of a computer operable to execute the disclosed architecture of a server, according to some embodiments.

FIG. 3 is a block diagram showing an exemplary administration server in accordance with one or more embodiments.

FIG. 4 illustrates a block diagram of an exemplary client-server computing environment in accordance with the methods and operations described herein.

FIG. 5 shows a flowchart of an illustrative process for allocation of popularity credits in a private communications network in accordance with one embodiment.

FIGS. 6 A-B show a flowchart of an example of the operation of the system of FIG. 1 in accordance with another embodiment.

FIG. 7 shows a flowchart of an illustrative process for allocation of popularity credit in a private communications networking in accordance with one embodiment.

Other features of the present embodiments will be apparent from the accompanying drawings and from the detailed description that follows.

### DETAILED DESCRIPTION

Disclosed are a system, method, and article of allocation of popularity credit in a private communications networking. Although the present embodiments have been described with reference to specific example embodiments, it will be evident that various modifications and changes can be made to these embodiments without departing from the broader spirit and scope of the various claims.

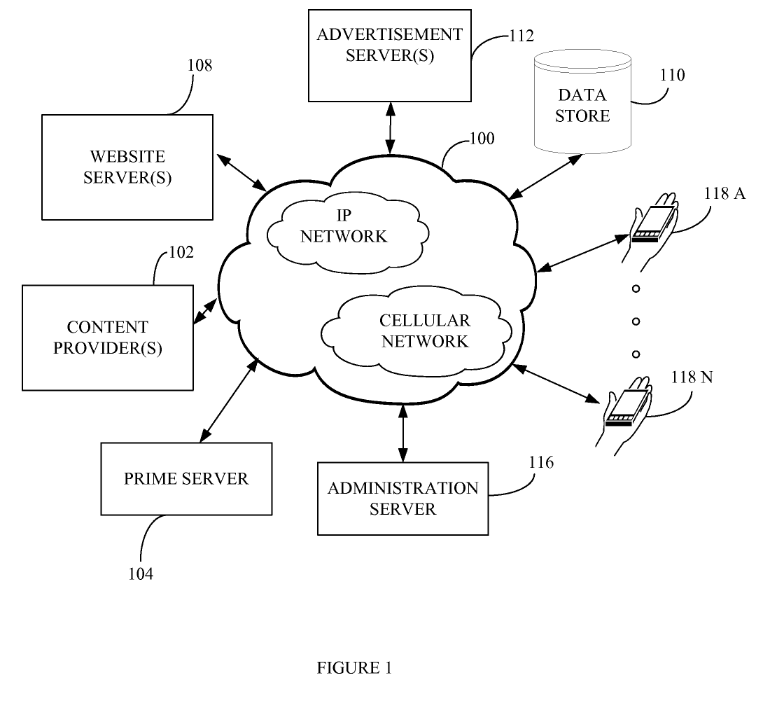

FIG. 1 is a block diagram showing a schematic view of an example private communications network for implementing one or more embodiments. The devices of the private communications network communicate via the communication network 100.

Communication network 100 can include any suitable circuitry, device, system or combination of these (e.g., a wireless communications infrastructure including communications towers and telecommunications servers) operative to create a computer network. Communication network 100 can provide wireless communications using any suitable short-range or long-range communications protocol. In some embodiments, communication network 100 can support, for example, Wi-Fi (e.g., an 802.11 protocol), Bluetooth™, high frequency systems (e.g., 900 MHz, 2.4 30 GHz, and 5.6 GHz communication systems), infrared, other relatively localized wireless communication protocols, or any combination thereof.

In some embodiments, communication network 100 can support protocols used by wireless and cellular phones and personal email devices (e.g., a smart phone). Such protocols can include, for example, GSM, GSM plus EDGE, CDMA, UMTS, quadband, and other cellular protocols. In another example, a long-range communications protocol can include Wi-Fi and protocols for placing or receiving calls using VoIP or LAN. Furthermore, in some embodiments, communication network 100 can include an internet protocol (IP) based network such as the Internet. In this way, the devices of FIG. 1 can transfer data between each other as well as with other computing devices (e.g. third party servers and databases) not shown for the purposes of clarity.

Additionally, in some embodiments, the communication network 100 can also include one or more local area networks (LAN) coupled to form a private wide area network (WAN). For example, a LAN can be implemented using Ethernet networking technology. The WAN can be a private network physically scaled to cover a geographic area sufficient to cover the private networks membership distribution. In some embodiments, the WAN may also be accessible via a secure website on the Internet. In some embodiments, a user may be required to create a user account and provide some user information before gaining access to the WAN. In other embodiments, a vetting process can be implemented to determine if user information has been truthfully provided before the user can access the WAN (e.g. a password, a username, a captcha). In some embodiments, portions of the private network can include such remote connection methods such as point-to-point protocol (PPP) and a virtual private network (VPN). In some embodiments, the private network may include elements of a public network. However, access to portions of the network such as certain websites and content can be restricted to such member entities as member users, content providers, server administrators and the like.

Generally, the content provider 102 can include both hardware and software applications to generate media content. Typical media content can include digital audio content (e.g. videos, movies, television shows, photographs), audio content (e.g. songs formatted in MP3 or other digital audio format) and/or other digital entertainment media development with a computer (e.g. video games, e-books). Some embodiments of FIG. 1 can include multiple content providers 102. Typically, content provider 102 can communicate media content to another device of FIG. 1, such as the prime server 104 and the website server 108, via communication network 100.

Generally, prime server 104 can include both hardware and software applications to manage the aggregation and distribution of specialized media content provided by one or more content providers 102. For example, the prime server 104 can aggregate videos of a particular genre. Prime server 104 can store aggregated media content in the data store 110.

Content provider 102 and/or prime server 104 can upload media content to the website server 108. In some embodiments, according to the rules of the private communications network of FIG. 1, a member user, such as member users 118A-N, can access media content stored in the private communications network through the website server 108. Typically, a website includes a collection of related web pages, images, videos or other digital assets that are addressed relative to a common addressing form such as a Uniform Resource Locator (URL). The website can be secured (e.g. employ encryption, password to login, a firewall) such that only members of the private communications network can access it. In addition to media content, in some embodiments, the website server 108 can also enable access to advertisements provided by the advertisement server 112. Media content and advertisements can be stored in the data store 110. Some embodiments of FIG. 1 can include more than one website servers 108.

Generally, advertisement server 112 can include both hardware and software applications to provide advertisements accessible via the website server 108. Typically, advertisements can be generated by third-party vendors. However, in some embodiments, prime server 104 and content provider 102 can also generate advertisements for their own respective media content. In some embodiments, access to the website server 108 for both advertisements and media content can be purchased with credits. A more detailed explanation of the rules governing the credit system of the private communication network of FIG. 1 is provided infra (see the description of the administration server 116). Advertisements can be stored in the data store 110.

Generally, administration server 116 can include both hardware and software applications to manage the behavior of entities in the private computer network. For example, the administration server 116 can enforce the rules of the private computer network. The administration server 116 can control access to the private computer network by outside users (e.g. provide registration services, provide password applications that control access). The administration server 116 can also manage the disbursement and remittance of credits by members of the private computer network. The administration server 116 can provide verification protocols and applications that ensure that member users 118A-N observes a specified portion of the media content or an advertisement before the credit is allocated to at least one of the content provider, the media-content website manager and the prime-server manager. Furthermore, the administration server 116 can enforce an agreement between the content provider 102 and the website server 108. Administration server 116 can ban a member for not abiding by a credit deferment agreement or other rule of the private communication network of FIG. 1.

Data store 110 can be used to store information related to the functions of the media-system manager via the administration server 116. For example, deferment agreement, credit data and/or registered member demographic information can be stored in data store 110.

Generally, member users 118A-N include end users of the private communications system of FIG. 1. Membership is limited to users who have registered with an administrative entity that manages the administration server 116. In some embodiments, the administration server 116 can charge a fee for membership privileges. Member users 118A-N can utilize any network enabled device such as a smart phone, a personal computer, a laptop and/or a tablet computer to access the media content hosted by the website server 108. In some embodiments, member user 118A-N can also function as content providers 102, prime servers 104 and/or advertisement providers. A member user 118A-N can acquire credits for providing these functions. Additionally, in some embodiments, a member user 118A-N can also acquire credits by viewing media content and/or advertisements. It should be noted that any element shown in FIG. 1 can be extant as a plurality of elements. For example, in some embodiments, a plurality of media-content web site servers, a plurality of content providers, a plurality of advertisement servers and/or a plurality of media-system manager servers can be extant within the system of FIG. 1.

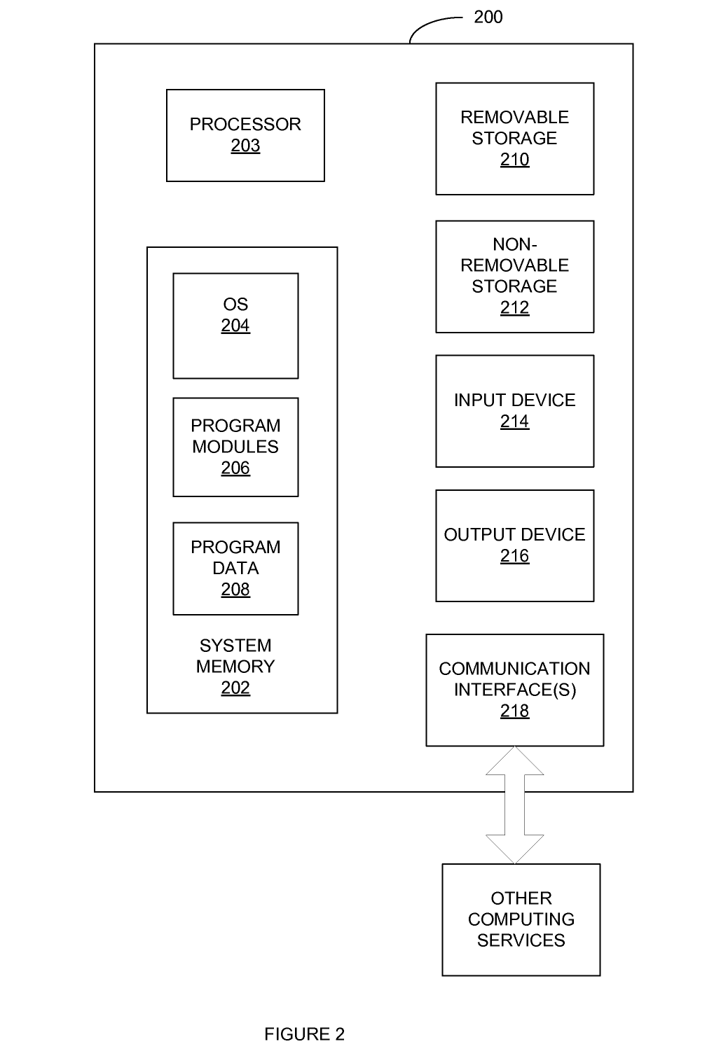

FIG. 2 shows a block diagram of a computer operable to execute the disclosed architecture of a server, according to some embodiments. In a basic configuration, the server 200 typically includes at least one processing unit 203 and system memory 202. Depending on the exact configuration and type of computing device, system memory 202 can be volatile (such as RAM), non-volatile (such as ROM, flash memory, etc.) or some combination of the two. The system memory 202 generally includes an operating system 204, one or more program modules 206, other program data 208

Server 200 can include additional features or functionalities. For example, the server 200 can also include additional data storage devices (removable and/or non-removable) such as, for example, magnetic disks, optical disks, or tape. Such additional storage is illustrated in FIG. 2 by removable storage 210 and non-removable storage 212. For example, computer storage media can include volatile and nonvolatile, removable and non-removable media implemented in any method or technology for storage of information, such as computer readable instructions, data structures, program modules, or other data. The system memory 202, removable storage 210 and non-removable storage 212 are all examples of computer storage media. Computer storage media includes, but is not limited to, RAM, ROM, EEPROM, flash memory or other memory technology, CDROM, digital versatile disks (DVD) or other optical storage, magnetic cassettes, magnetic tape, firmware, magnetic disk storage or other magnetic storage devices, or any other medium which storage media can be part of the server 200. These computer storage media can include computer-executable instructions for implementing the various embodiments described herein. The server 200 can also have input device(s) 214 such as a keyboard, a mouse, a pen, a voice input device, a gesture-based interface and/or a touch-sensitive input device. Output device(s) 216 such as a display, speakers, printer, etc. can also be included.

The server 200 can also include communication interfaces 218 that allow the device to communicate with other computing devices over a communication network. Communication interfaces 218 are one example of communication media. Communication media can be embodied by computer readable instructions, data structures, program modules, or other data in a modulated data signal, such as a carrier wave or other transport mechanism, and includes any information delivery media. The “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. The computer readable media as used herein can include both storage media and communication media according to various example embodiments.

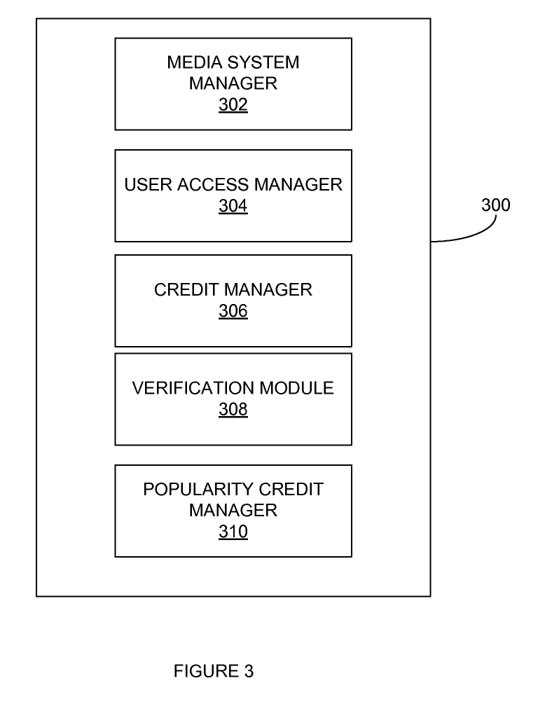

FIG. 3 is a block diagram showing an exemplary administration server in accordance with one or more embodiments. In some embodiments, administration server 116 can include a media-system manager 302. Media-system manager 302 can include functionalities that enforce the rules of the private communications network of FIG. 1. Media-system manager 302 can also provide a user interface for an administrator to input data and instructions regarding the operations of the private communications network. Media-system manager 302 can control which devices have access to the private communications network as well as the role each device is allowed to perform. For example, media-system manager 302 can provide permission for a content provider 102 to upload content to the website server 108. In some embodiments, media-system manager 302 can provide instructions to the other modules of the administration server 116.

User access manager 304 can include functionalities that control access of member users to the private communications network of FIG. 1. In some embodiments, User access manager 304 can manage authorization, authentication and accounting protocols to secure the private communications network. For example, user access manager 304 can provide an access control list (ACL) to the various servers of the private communications network. The ACL can define what members users can do with a particular server's resources. User access manager 304 can store a database of authorized member users, member-user passwords and their permitted actions in data store 110.

Credit manager 306 can include functionalities that allow members of the private communications network (e.g. a content provider) charge credits for access to services and/or content (e.g. media content, advertisement content, server hosting and the like) controlled by the entity. Credit manager 306 can track the use of credit in the private communications network. The amount of credit a particular entity can charge can be controlled by the private communications network administrator via the credit manager 306. In some embodiments, the amount can be set according to such factors as the relative popularity of the service and/or content, the type of service and/or content, the value of similar services and/or content, and the like. Popularity can be determined according to particular metric such as number of user views, success of advertisements associated with content and/or website, average time a user spends on a website or viewing media content, or any combination thereof. In some embodiments, an entity can provide a credit value for its service or content. In such a case, the private communications network administrator can implement limits on entity determined credit values.

The credit manager 306 can record the amount of credit earned by each entity of the private communications network of FIG. 1. This credit data can be stored in data store 110. Additionally, credit manager 306 can manage the remittance of credits for privileges within the private communications network. In some embodiments, credits are earned by providing access to a device's and/or member's services. Credits can also be earned when a member user utilizes a service such as watching an advertisement and/or media content on a website hosted by the website server 108. Additionally, credit manager 306 can store the data related to credit deferment agreements, earned credits, how credits are utilized by members, and the like. The credit manager 306 can store this data in data store 110. An entity of the private communications network can acquire this data from the credit manager 306. In this way, credit data can be utilized as a feedback mechanism whereby other members can imitate the patterns and actions followed by successful members. It should be noted that other utilities, applications and devices of the administration server 116 have not been shown for the purposes of clarity.

Verification module 308 can include a set of functionalities that verify whether a member user observes a specified portion of at least one of a media content and/or an advertisement associated with the media content. Verification techniques can include operations to verify user presence. For example, the member user may be prompted to press a certain button or keypad key in order to confirm that they are paying attention. In one implementation, the approaches for verifying user presence can be made progressively more aggressive if the user has failed a previous test. For example, after the user fails the test the first time, the subsequent tests can be made to appear more frequently or at varying times. As another example, the test(s) can be made more subtle so as to render them more difficult to perceive, such as by reducing the size of a message box on the screen, or by making an audio prompt more similar to the advertisement in which it inserted. If the member user fails the test the verification module can present another test to the user or the user can perform the test over again while the entire advertisement can be played again. Example user tests can include a captcha, simple actions such a pressing a specified key or saying a specified word into a speaker, input of the user's password, and the like. In some embodiments, the verification module can include a client application that resides in the programmable memory of the member user's computer. Verification module 308 can also communicate with a vendor to verify a purchase by a member user 118 A-N of a good or service advertised in the private communications network of FIG. 1.

Popularity credit manager 310 can monitor actions of entities in the private communications network of FIG. 1. Popularity credit manager 310 can allocate popularity credits to an entity for specified actions such as contributing media content, advertisement content, hosting a website, storing media content and/or advertisement content, providing network analytics (e.g. gathering entity data and making the data accessible to other entities), and the like. Popularity credit manager 310 can prorate popularity credits. For example, popularity credit manager 310 can prorate popularity credits among a plurality of entities according to their contributions to a particular user experience. Popularity credit manager 310 can then store allocated popularity credit information. Popularity credits can be formatted for digital distribution to the member entities. For example, a popularity credit can be formatted as an electronic popularity coupon. Popularity coupons can be digitally transmitted to the respective member entities (e.g. email, instant messaging, text). Entity members of the private communications network can use popularity credits as a form of credit to access system resources such as those provided by member entities (e.g. media content, server memory and processing power, advertise on a particular website, etc). In this way, popularity credits are always reabsorbed into the system to influence the behavior of member entities. In some embodiments, other forms of system credit can be exchanged for popularity credits as well. The administration server 116 can regulate the exchange and allocation of popularity credits. Popularity credit manager 310 can also store how member entities use popularity credits. Popularity credit manager 310 can provide this information to other member entities along with other member user behavioral information. In some embodiments, popularity credit manager 310 can include client applications that are stored in the memory of networking devices used by member entities to access the private communications network. In this way, popularity credit manager 310 can monitor and mediate the use of popularity credits.

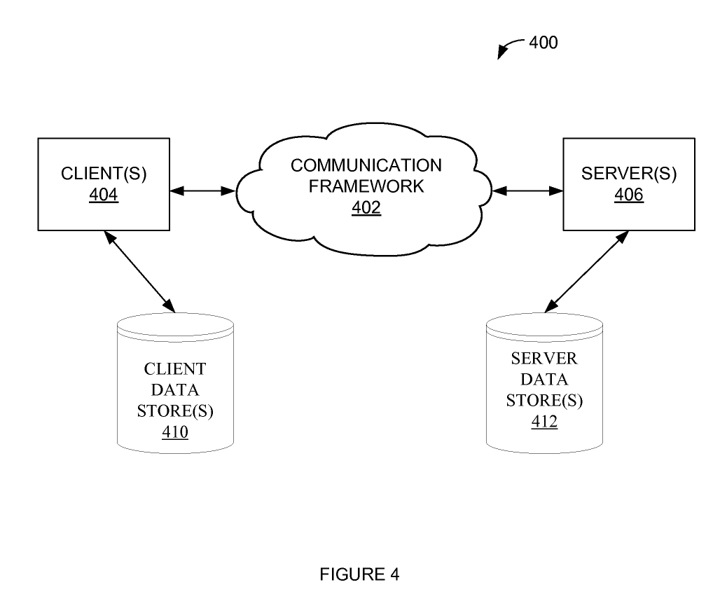

FIG. 4 illustrates a block diagram of an exemplary client-server computing environment 400 in accordance with the methods and operations described herein. The system 400 includes one or more client 404. The client 404 can be hardware circuitry and/or software applications (e.g., threads, processes, computing devices), that initiates communications with the server 406 according to the client-server communication paradigm. Client 404 can be implemented in a variety of ways, including as a computer, portable digital assistant (PDA), communication device, and the like. Clients 404 are equipped with conventional mechanisms to receive the communication framework 402, such as ports, network cards, receivers, modems, and so on. Client 404 can house cookie(s) and/or associated contextual information to perform the methods and operations of some embodiments.

System 400 also includes one or more servers 406. In some embodiments, server 406 can also be hardware circuitry and/or software applications (e.g., threads, processes, computing devices). Server 406 can house threads to perform the methods and operations described by herein. One possible communication between a client 404 and a server 406 can be in the form of a data packet adapted to be transmitted between two or more computer processes. The data packet can include a cookie and/or associated contextual information, for example. Server 406 can be implemented in a number of ways, such as a host server of a website, a dedicated search engine (e.g., that stores information for searching but not the content for search hits), telecommunications server and so forth. The content can be organized and made available to client 406 in any of a wide variety of conventional manners. The information communicated from server 406 may be in any data type (e.g., text, graphics, audio, video, etc.) and contain essentially any type of subject matter.

System 400 includes a communication framework 402 (e.g., communications network 300, the Internet, etc) that can be employed to facilitate communications between the client 404 and the server 406. Communications can be facilitated via a wired (including optical fiber) and/or wireless technology. Client 404 can be communicatively connected to one or more client data stores 410 that can be employed to store information local to the client 404 (e.g., cookie(s) and/or associated contextual information). Similarly, the server 406 can be operatively connected to one or more server data stores 412 that can be employed to store information local to the server 406. It should be noted, that in some embodiments, a particular application can function as a client in one context or operation and as a server in another context or operation.

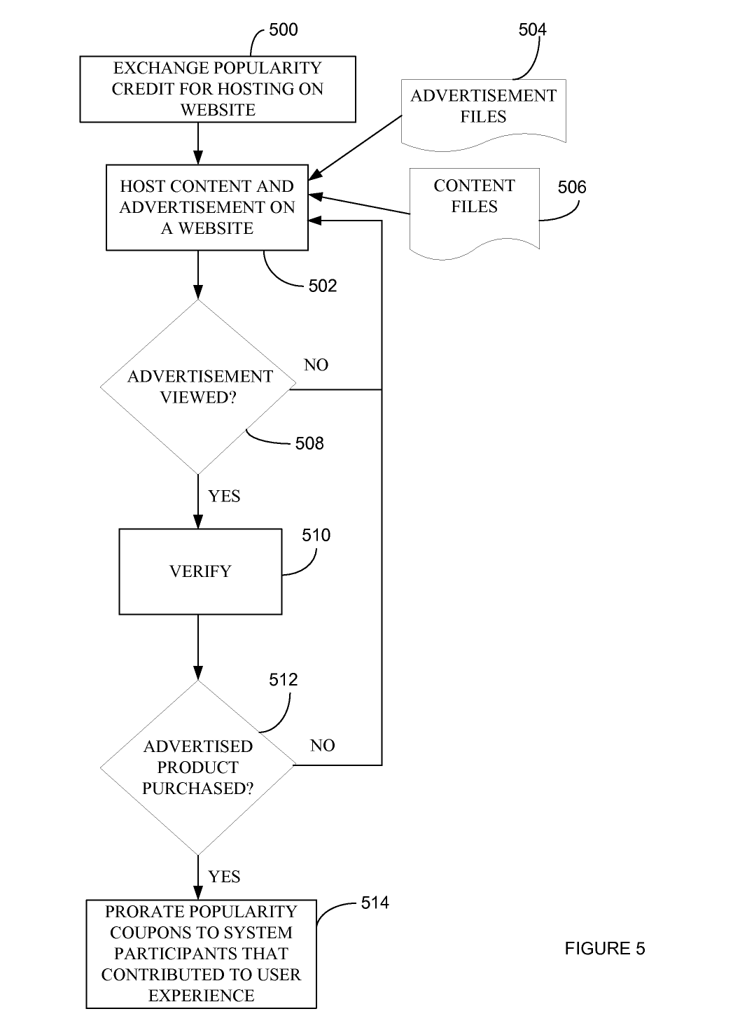

FIG. 5 shows a flowchart of an illustrative process for allocation of popularity credits in a private communications networking in accordance with one embodiment. In block 500, popularity coupons can be redeemed for hosting the content media and advertisement on a website of the private communication system. The popularity credits may have been allocated to the website host 108 by the popularity credit manager 310 for a participation in a previous action in the private network of FIG. 1. In block 502, website host hosts advertisements and media content on at least one website. Website server 108 can acquire the content by uploading advertisement files 504 and/or media content files 506 from other member entities. Member users can access the content on the website. Decision 508 shows that if an advertisement is viewed, website server can provide the administration server 116 information to verify user presence during the period the advertisement played on the website. Additionally, website host can present verification protocols to the user. Verification protocols can be received from the administration server 116. If the advertisement is not viewed, it can be replayed on the website. In block 510, the administration server can verify that the advertisement played on the website. In 512, the administration server 116 can verify whether a good or service was purchased from a vendor featured in the advertisement. If the good or service was purchased then the administration server 116 can prorate popularity credits to the system entities that contributed to the user experience that led to the purchase of the good or service in block 514.

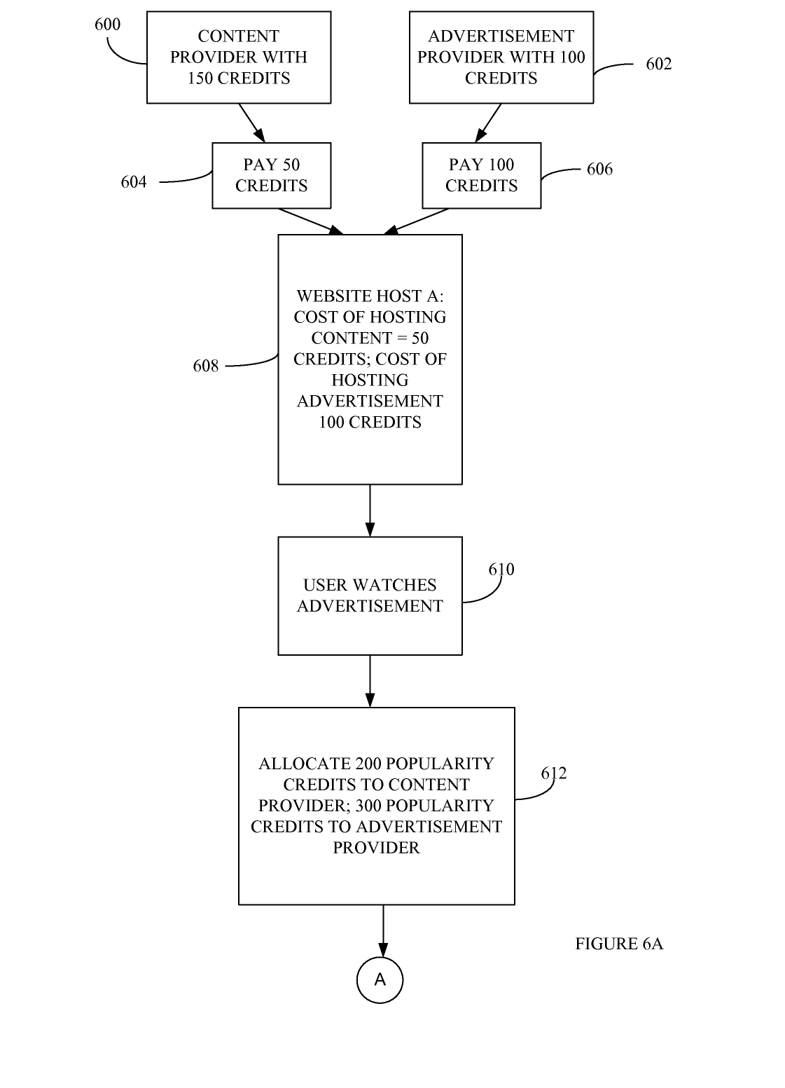

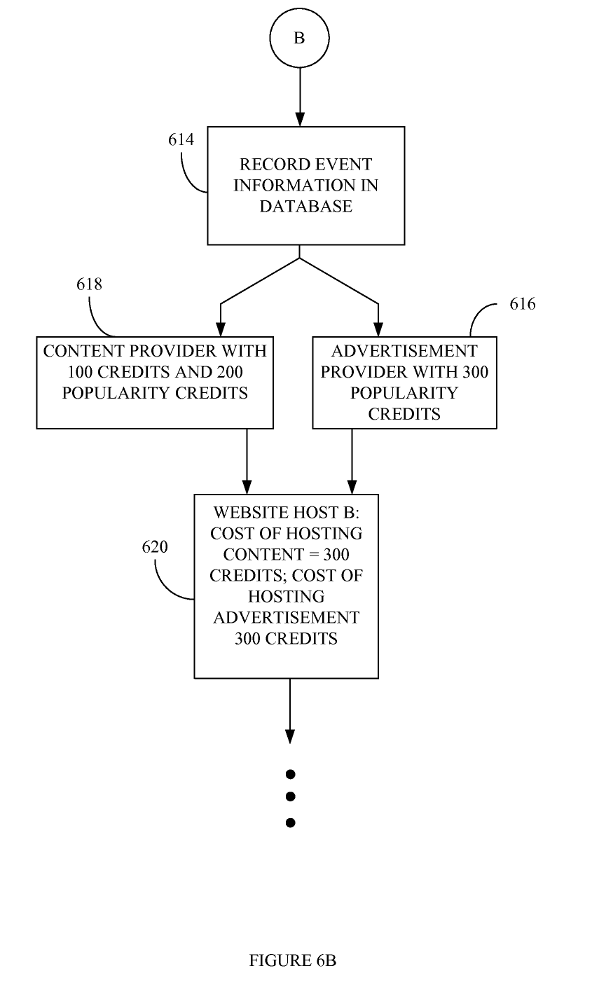

FIGS. 6 A-B shows a flowchart of an example of the operation of the system of FIG. 1 in accordance with another embodiment. Block 600 shows a content provider with one-hundred and fifty credits. Block 602 shows an advertisement provider with one hundred credits. In blocks 604 and 606, the content provider and advertisement provider pay the respective credit amounts required by website host A to host their content (e.g. advertisements, media such as video, songs, educational material, etc). Block 608 shows the respective costs charged by website host A. As the content is hosted on a website, it can be observed by a user of the system as exemplified by block 610. In block 612, if the user ‘clicks through’ the advertisement, the content provider and the advertisement provider are allocated popularity credits as an incentive for providing successful content (i.e. content that attracted a user and instigated a sale of an advertised product). In block 614, the information regarding the event that led to the allocation of the popularity credits as well as the allocation of the popularity credit information is recorded in a database. The database can be accessible to other members of the system. Allocated popularity credits can and/or available system credits can then be used to purchase hosting access from another, more expensive, website host in block 620. As indicated, the process illustrated in FIGS. 6 A-B can continue. In some embodiments, the popularity credits aid the content provider and the advertisement provider to take advantage of success (e.g. in terms of motivating users to a website and ‘clicking through’ an advertisement). Thus, a successful member entity can accelerate access and exposure to users of the private communication system through the awarding and use of popularity credits as a reward for providing successful content.

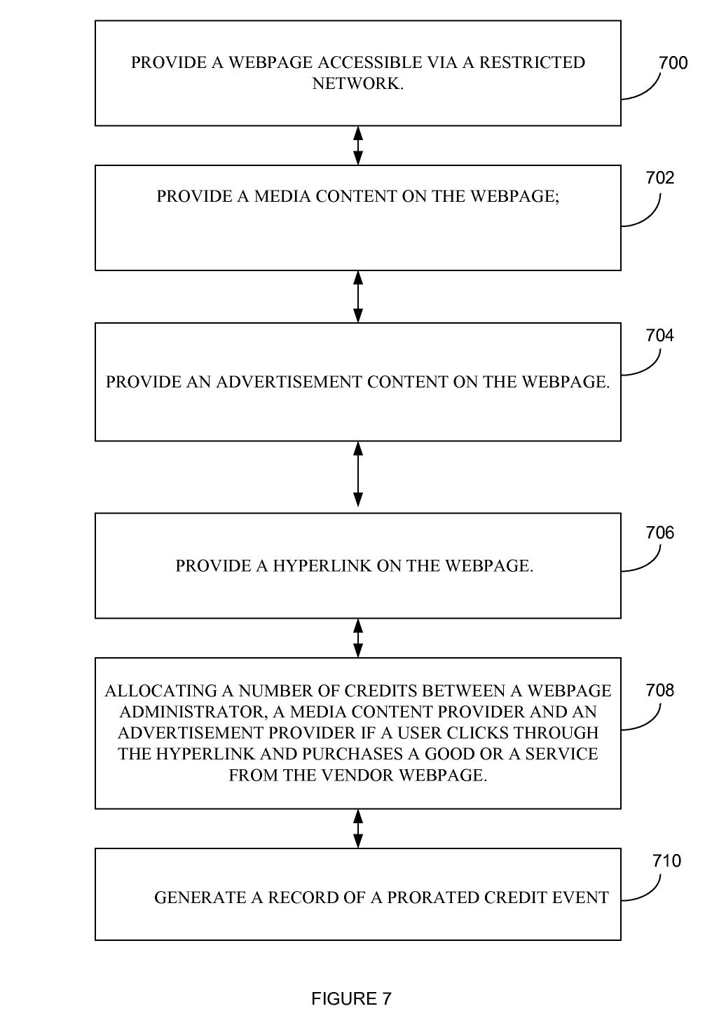

FIG. 7 shows a flowchart of an illustrative process for allocation of popularity credit in a private communications networking in accordance with one embodiment. Block 700 typically indicates providing a webpage accessible via a restricted network. Block 702 typically indicates providing a media content on the webpage. Block 704 typically indicates that an advertisement content on the webpage is provided. Block 706 typically indicates that a hyperlink is provided on the webpage. The hyperlink includes a reference that instructs a web browser to access a vendor webpage. The webpage can be hosted by a server of a website server 108. Block 708 typically indicates that a number of credits are allocated between a webpage administrator, a media content provider and an advertisement provider if a user clicks through the hyperlink and purchases a good or a service from the vendor webpage. This operation can be performed by the popularity credit manager 310. Block 710 typically indicates generating a record of the prorated credit event. Again, this operation can be performed by the popularity credit manager 310. In some embodiments, the record can be made available to any other member of the network. The record can be used to analyze the popularity of various content of the network. The record can also influence what content particular entities chose to do with popularity credits.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data. The local computer may execute any computer-executable instructions. Alternatively, the local computer may download pieces of the software or data as needed, or distributively process the software by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” typically refers to executable instructions, code, data, applications, programs, or the like maintained in an electronic device such as a ROM. The term “software” generally refers to executable instructions, code, data, applications, programs, or the like maintained in or on any form of computer-readable media. The term “computer-readable media” typically refers to system memory, storage devices and their associated media, and the like.

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium). Accordingly, the specification and drawings are to be regarded in an illustrative rather than a restrictive sense.

What is claimed is:

1. A computer-implemented private communications network comprising:
an entity member of the private communications network that provides a media content to a website member of the private communications network;
another entity member of the private communications network that provides an advertisement content;
a server that hosts the website, wherein the website comprises the advertisement content, the media content and a hyperlink to a vendor website outside the private communications network; and
an administration server that comprises:
a verification module that determines whether a user purchased a good or a service from the vendor website; and
a popularity credit manager that generates a list of entities that provided the media content or hosted the media content, that allocates a popularity credit to the each listed entity member if the user purchased the good or the service from the vendor website, that tracks the allocation and redemption of popularity credits within the private communication network, that provides a popularity credit database that is available to a member of the private communication network, and wherein the popularity credit database comprises popularity credit allocation data and popularity credit redemption data; and
a user access manager that controls user access to the private communications network.

2. The computer-implemented private communications network of claim 1, wherein the popularity credit is redeemable by a website administrator to acquire the media content.

3. The computer-implemented private communications network of claim 1, wherein the popularity credit is redeemable by a website administrator to acquire the advertisement content.

4. The computer-implemented private communications network of claim 1, wherein popularity credit manager allocates the popularity credit to the other entity member that provided the advertisement content if the user purchased the good or the service from the vendor website.

5. The computer-implemented private communications network of claim 1, wherein a plurality of entities generate the media content.

6. The computer-implemented private communications network of claim 5, wherein the popularity credit manager allocates each entity member of the plurality of entities a partial unit of the popularity credit.

7. The computer-implemented private communications network of claim 1, wherein the entity member redeems a popularity credit to have the media content hosted on the website.

8. The computer-implemented private communications network of claim 1, wherein the entity member redeems a specified portion of the popularity credit to have the media content hosted on the website for a specified period of time.

9. The computer-implemented private communications network of claim 1, wherein the other entity member redeems a popularity credit to have the advertisement content hosted on the website and associated with the media content.

10. The computer-implemented private communications network of claim 1, wherein the media content comprises a digital video.

11. A method of a computer-implemented restricted network comprising:
providing a webpage accessible via the restricted network;
providing a media content on the webpage;
providing an advertisement content on the webpage;
providing a hyperlink on the webpage, wherein the hyperlink comprises a reference that instructs a web browser to access a vendor webpage; and
allocating a number of popularity credits between a webpage administrator, a media content provider and an advertisement provider if a user clicks through the hyperlink and purchases a good or a service from the vendor webpage.

12. The method of a computer-implemented restricted network of claim 11 further comprising:
generating a record of a popularity credit allocating event, wherein the record comprises a list of each participant, an amount of credit allocated, an identity of the media content, an identity of the advertisement and an identity of the vendor webpage.

13. The method of a computer-implemented restricted network of claim 12 further comprising:
communicating the record the popularity credit allocating event to a member entity of the restricted communications network.

14. The method of the computer-implemented restricted network of claim 11, wherein the webpage is accessible by a member of the restricted communications network.

15. The method of the computer-implemented restricted communications network of claim 14, wherein the restricted communications network comprises a computer network with a restricted internet protocol (IP) address space accessible only to a computer logged into the restricted communications network.

16. The method of a computer-implemented restricted network of claim 11 further comprising:
mediating an exchanging of a popularity credit for access to a resource of the restricted network.

17. The method of a computer-implemented restricted network of claim 11:
wherein a popularity credit comprises credit to acquire a resource of the restricted network, and
wherein the resource of the restricted network comprises the media content, the advertisement content or inclusion as an element of the webpage.

18. The computer-implemented restricted network of claim 11, wherein a machine is caused to perform the method of claim 11 when a set of instructions in a form of a machine-readable medium is executed by the machine.

19. A computer-implemented method of using the results of providing a webpage accessible via a computer network; providing a media content on the webpage; providing an advertisement content on the webpage; and providing a hyperlink on the webpage, wherein the hyperlink comprises a reference that instructs a web browser to access a vendor webpage comprising:
allocating a number of popularity credits between a webpage administrator, a media content provider and an advertisement provider if a user clicks through the hyperlink and purchases a good or a service from the vendor webpage.

20. The method of a computer-implemented computer network of claim 19 further comprising:
producing a statistical analysis of each member user and the allocation of popularity credits in the computer network; and
formatting a web page document accessible to each member of the computer network, wherein the web page document comprises the statistical analysis.
